(19) United States
(12) Patent Application Publication
(10) Pub. No.: US 2010/0066900 A1
(43) Pub. Date: Mar. 18, 2010

(54) IMAGE PROCESSING METHOD

(75) Inventors: Wen-Long Lin, Tainan County (TW); Chung-Chieh Kang, Tainan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HIMAX TECHNOLOGIES LIMITED, Tainan County (TW)

(21) Appl. No.: 12/209,516

(22) Filed: Sep. 12, 2008

(51) Int. Cl. H04N 7/01

(52) U.S. Cl. 348/441; 348/E07.003

(57) ABSTRACT

An image data processing method. The method includes fetching a plurality of image layers to be overlappingly displayed on a display area; expanding the fetched image layers to have the same size as the display area of a video frame; merging the expanded image layers in an interleaving manner; and storing the merged image layer in a memory device sequentially.

### BACKGROUND OF THE INVENTION

1. Field of the Invention

The invention relates to an image processing method, and more particularly to an interleaving image layer for access by a graphic display system.

2. Description of the Related Art

Video frames may include two or more image layers overlappingly displayed. For example, the image layers may be MPEG-A layer, MPEG-B layer, on screen display (OSD)-A layer, OSD-B layer, JPEG layer, hardware cursor (HCUR) layer and Graphics layer. Conventionally, different image layers are stored in a dynamic random access memory (DRAM) and respectively located at different banks. As shown in FIG. 1, different image layers are separately stored in different banks 1-m of the DRAM, therefore, when accessing different image layers in the DRAM, it may be time-consuming to perform bank changes. Conventionally, we may increase the operating frequency of the DRAM or insert a command cue in the memory controller to improve the utilization of the DRAM, however, it suffers unexpected power consumption or may not function all the time. Therefore, a novel implementation to improve the utilization of the DRAM without increasing the operation frequency of the DRAM or inserting a command cue in the memory controller is highly desired.

### BRIEF SUMMARY OF THE INVENTION

Image processing methods are provided. An exemplary embodiment of the method comprises fetching a plurality of image layers to be overlappingly displayed on a display area; expanding the fetched image layers to have the same size as the display area of a video frame; merging the expanded image layers in an interleaving manner; and storing the merged image layer in a memory device sequentially.

Another exemplary embodiment of the method comprises fetching data units from an interleaved image layer by a plurality of devices in a cyclic manner, wherein the interleaved image layer is interleaved by data units of a corresponding number of image layers, such that corresponding data units that are in respective image layers and to be overlappingly displayed are adjacently arranged and such that each of the device may have its corresponding data units; combining the fetched data units for the devices; and outputting the combined outcome for display.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a graphic display system;

FIG. 2 shows a video frame that is composed of three exemplary image layers overlappingly displayed on the display area;

FIG. 3 shows the data structures of original and expanded image layers in FIG. 2;

FIG. 4 shows the data structure of an interleaved image layer of the expanded image layers in FIG. 3 according to the embodiments of the invention;

FIG. 5 shows a flow chart describing an image processing method according to one embodiment of the invention; and

FIG. 6 shows a flow chart describing an image processing method according to another embodiment of the invention.

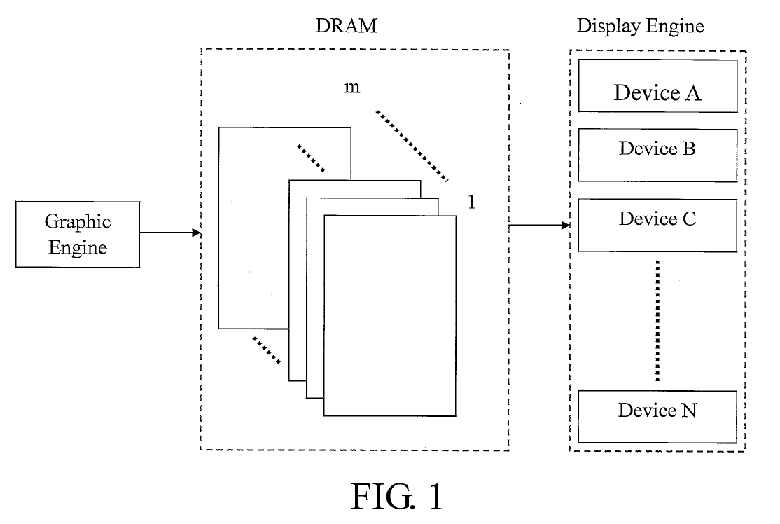

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

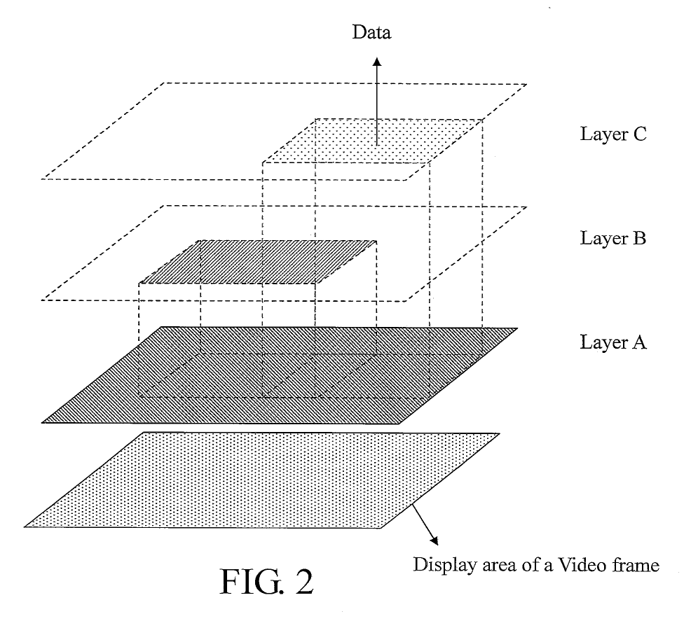

Video frames may include two or more image layers overlappingly displayed. For example, the image layers may be MPEG-A layer, MPEG-B layer, OSD-A layer, OSD-B layer, JPEG layer, HCUR layer and Graphics layer. FIG. 2 shows an exemplary video frame that is comprised of three image layers A, B and C overlappingly displayed on a display area.

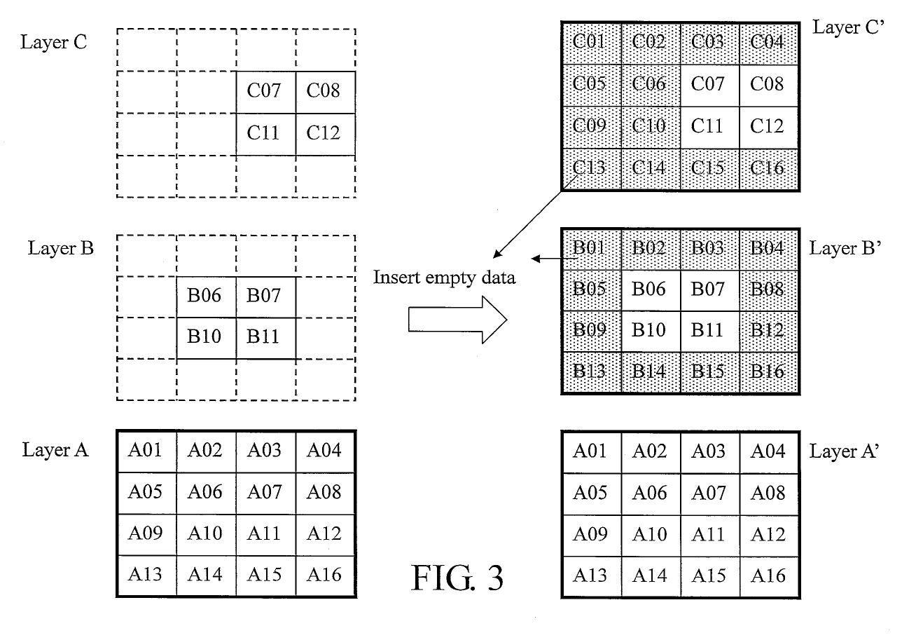

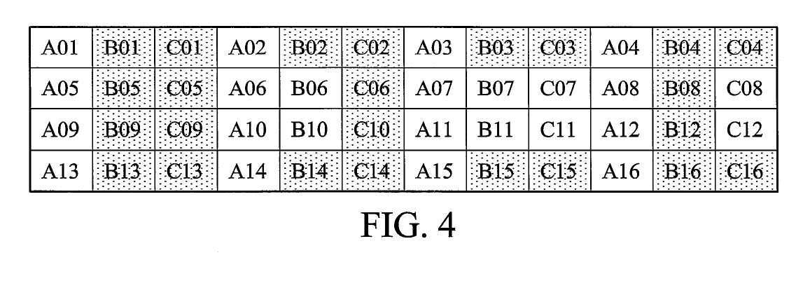

Conventionally, these image layers A-C are stored in a dynamic random access memory (DRAM) and respectively located at different banks. FIG. 3 shows the data structures of the image layers A-C. As shown in FIG. 3, the image layer A has the same size as the video frame and is divided into data units A01-A16, the image layer B has a smaller size than the video frame and is divided into data units B06-B07 and B10-B11, and the image layer C has a smaller size than the video frame and is divided into data units C07-C08 and C11-C12. A data unit may include one, two, four or eight successive pixels and may be modified as needed. In this case, when different devices of a display engine accesses the image layers A-C for later processing and displaying, it may take a lot of time performing repetitive bank changes to fetch the image layers A-C, thus lowering the performance of the DRAM. In order to increase efficiency when accessing the image layers stored in the DRAM, a novel interleaving data structure and its image processing method is proposed. As shown in FIG. 3, each of the image layers A-C is first expanded to have the same size as the display area by inserting empty data, such that the expanded image layers A′-C′ may all have the same size as the video frame. In this case, corresponding data units in the expanded image layers A′-C′ are to be overlappingly displayed at the same position. For example, data units A06 and B06 in the expanded image layers A′ and B′ are to be overlappingly displayed at the same position, data units A07, B07 and C07 in the expanded image layers A′-C′ are to be overlappingly displayed at the same position, . . . and so on. The expanded image layers A′-C′ are then merged into a bigger one in an interleaving manner. As shown in FIG. 4, corresponding data units A01, B01 and C01 in the expanded image layers A′-C′ are adjacently placed in the DRAM, followed by the next corresponding data units A02, B02 and C02, . . . and so on.

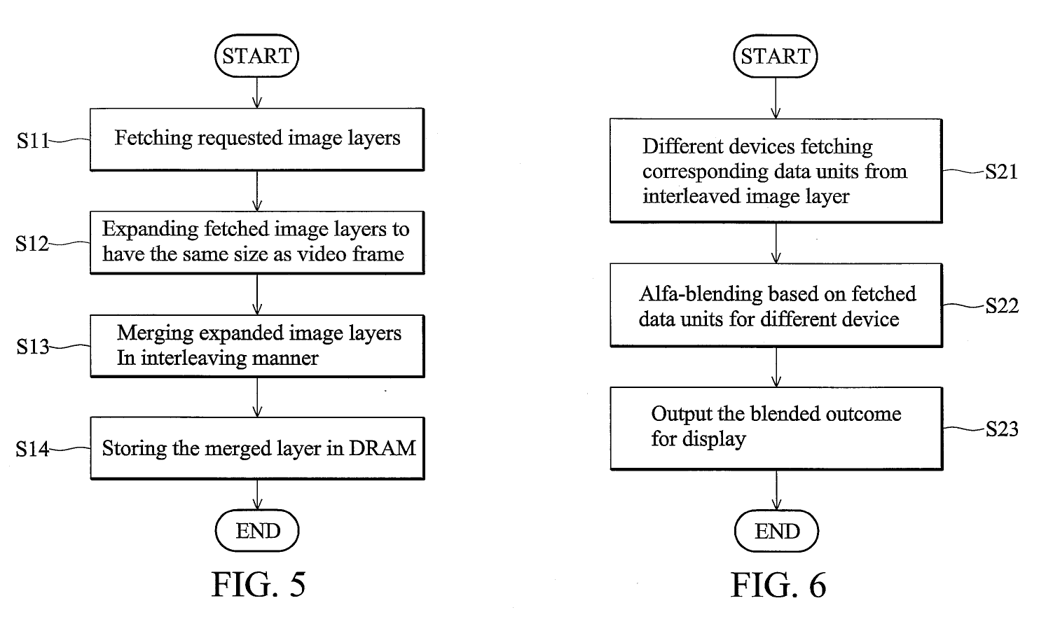

FIG. 5 shows a flow chart of the image processing method according to one embodiment of the invention. First, as shown in STEP S11, the graphic engine fetches the image layers to be overlappingly displayed on the display area. The fetched image layers are may have the same size as the video frame or may only occupy a portion of the video frame. Next, as shown in STEP S12, the fetched image layers are expanded such that all the fetched image layers may have the same size of video frame. The expanding step may be done by inserting empty data in the original image layers, such that corresponding data units in the expanded image layers are to be overlappingly displayed on the display area, as shown in FIG. 3. In STEP S13, the expanded image layers are merged into a bigger one. The merging step can be done in an interleaving manner, such that corresponding data units in respective expanded image layers and to be overlappingly displayed are adjacently arranged, as shown in FIG. 4. After that, in STEP S14, the interleaved image layer is stored in the DRAM for later accessing, processing and displaying.

FIG. 6 shows a flow chart of the image processing method according to another embodiment of the invention. First, as shown in STEP S21, different devices of the display engine fetches data units of an interleaved image layer from the DRAM in a cyclic manner. The interleaved image layer is interleaved by data units of two or more image layers, such that when different devices of the display engine fetch the data units of the interleaved image layer in a cyclic manner, each of the devices can have its data units. For example, if data units of images layers A′-C′ are merged in an interleaving manner, as shown in FIG. 4, when devices A-C fetch the data units of the interleaved image layer in a cyclic manner, that is, the device A fetches the first data unit A01, the device B fetches the second data unit B01, the device C fetches the third data unit C01, then the device A again fetches the fourth data unit A02, . . . and so on, each of the devices A-C can have its corresponding data units. Then, as shown in STEP S22, the display engine alpha-blends the fetched data units for different devices. Next, as shown in STEP S23, the alpha-blended outcome can be output for display on the display area.

With the interleaved image layer stored in the DRAM, the display engine can access different image layers continually, thus reducing the frequency of bank changes and increasing the efficiency of the DRAM.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image processing method, comprising:
fetching a plurality of image layers to be overlappingly displayed on a display area;
expanding the fetched image layers to have the same size as the display area of a video frame;
merging the expanded image layers in an interleaving manner; and
storing the merged image layer in a memory device sequentially.

2. The image processing method as claimed in claim 1 is implemented by a graphic engine.

3. The image processing method as claimed in claim 1, wherein the expanding step comprises:
inserting empty data to the image layers smaller than the display area, such that corresponding data units for all the expanded image layers are to be overlappingly displayed on the display area.

4. The image processing method as claimed in claim 3, wherein each of the data units may be one, two, four or eight successive pixels.

5. The image processing method as claimed in claim 4, wherein the merging step comprises:
interleaving the data units for all the expanded image layers one by one such that corresponding data units that are in respective expanded image layers and to be overlappingly displayed are adjacently arranged.

6. The image processing method as claimed in claim 1, wherein the memory device is a dynamic random access memory.

7. The image processing method as claimed in claim 1, wherein each of the image layers can be selected from a group including a MPEG layer, an on screen display (OSD) layer, a hardware cursor (HCUR) layer, a Graphics layer and a JPEG layer.

8. An image processing method, comprising:
fetching data units from an interleaved image layer by a plurality of devices in a cyclic manner, wherein the interleaved image layer is interleaved by data units of a corresponding number of image layers, such that corresponding data units that are in respective image layers and to be overlappingly displayed are adjacently arranged and such that each of the device may have its corresponding data units;
combining the fetched data units for the devices; and
outputting the combined outcome for display.

9. The image processing method as claimed in claim 8 is implemented by a display engine.

10. The image processing method as claimed in claim 8, wherein:
the interleaved image layer is stored in a memory device.

11. The image processing method as claimed in claim 10, wherein:
the memory device is a dynamic random access memory.

12. The image processing method as claimed in claim 8, wherein:
each of the image layers can be selected from a group including a MPEG layer, an on screen display (OSD) layer, a hardware cursor (HCUR) layer, a Graphics layer and a JPEG layer.

13. The image processing method as claimed in claim 8, wherein each of the data units may be one, two, four or eight successive pixels.

14. The image processing method as claimed in claim 8, wherein the combining step comprises:
Alpha-blending the fetched data units that are in respective image layers and to be overlappingly displayed.
